(19) United States
(12) Patent Application Publication
(10) Pub. No.: US 2021/0339250 A1
(43) Pub. Date: Nov. 4, 2021

(54) CENTRIFUGAL MICROFLUIDIC SYSTEM

(71) Applicants: Alireza Balaei Ghahjaverstani, Tehran (IR); Manouchehr Eghbal, Tehran (IR); Ehsan Mahmoudi Arjmand, Freiburg (DE)

(72) Inventors: Alireza Balaei Ghahjaverstani, Tehran (IR); Manouchehr Eghbal, Tehran (IR); Ehsan Mahmoudi Arjmand, Freiburg (DE)

(73) Assignees: Alireza Balaei Ghahjaverstani, Tehran (IR); Manouchehr Eghbal, Tehran (IR); Ehsan Mahmoudi Arjmand, freiburg (DE)

(21) Appl. No.: 17/378,716

(22) Filed: Jul. 18, 2021

Related U.S. Application Data
(60) Provisional application No. 63/053,581, filed on Jul. 18, 2020.

(51) Int. Cl. B01L 3/00

(52) U.S. Cl. CPC B01L 3/502753; B01L 3/50273; B01L 3/502738; B01L 3/502746; B01L 2300/0806; B01L 2400/0475; B01L 2400/06; B01L 2400/0409; B01L 2400/043; B01L 2200/0689

(57) ABSTRACT

A centrifugal microfluidic system. The centrifugal microfluidic system includes a top layer, a bottom layer, and a middle layer. The middle layer may include an inlet chamber, a radial guide channel, a moveable magnet, a first connecting channel, a sealing beam, a target chamber, a second connecting channel, and a first stationary magnet. When the middle layer rotates around the center of the middle layer with a speed less than a threshold rotational speed, the fluid sample is prevented from flowing to the target chamber from the inlet chamber. When the middle layer rotates around the center of the middle layer with a speed greater than the threshold rotational speed, the fluid sample is allowed to flow to the target chamber from the inlet chamber through the first connecting channel and the second connecting channel.

### CROSS-REFERENCE TO RELATED APPLICATION

This application claims the benefit of priority from pending U.S. Provisional Patent Application Ser. No. 63/053,581, filed on Jul. 18, 2020, and entitled “MAGNETIC SEMI-ACTIVE VALVE AND PUMP FOR CENTRIFUGAL MICRO-FLUIDIC SYSTEMS” which is incorporated herein by reference in its entirety.

### TECHNICAL FIELD

The present disclosure generally relates to microfluidic devices and platforms for biological analysis. This disclosure particularly relates to centrifugal compact disc (CD) devices that are utilized in a single system or platform to perform multiple processes.

### BACKGROUND

A target blood components may be separated from a biological sample, such as blood plasma, via numerous different approaches using silica, glass fiber, anion exchange resin, or magnetic beads. In an approach using magnetic beads, magnetic beads having surface functional groups capable of being combined with a target biomaterial may be placed in a sample to trap the target biomaterial, and then may be separated from the sample in order to extract the target biomaterial from magnetic beads. The magnetic beads separation approach has been widely used in order to separate cells, proteins, nucleic acids, or other biomolecules.

Meanwhile, various microfluidic systems that can perform various reactions in a single unit in order to analyze and process a sample solution have been proposed. As one example in this regard, compact disc (CD)-shaped microfluidic systems which moves a solution sample using a centrifugal force in a compact disc-shaped microfluidic unit have been developed. However, these systems are expensive and complex. There is, therefore, a need for inexpensive and simple systems that can move a solution sample using a centrifugal force in a compact disc-shaped microfluidic platform.

### SUMMARY

This summary is intended to provide an overview of the subject matter of the present disclosure, and is not intended to identify essential elements or key elements of the subject matter, nor is it intended to be used to determine the scope of the claimed implementations. The proper scope of the present disclosure may be ascertained from the claims set forth below in view of the detailed description below and the drawings.

In one general aspect, the present disclosure describes an exemplary centrifugal microfluidic system. An exemplary centrifugal microfluidic system may include a top layer, a bottom layer, and a middle layer. In an exemplary embodiment, the middle layer may be secured between the top layer and the bottom layer.

In an exemplary embodiment, the middle layer may include an inlet chamber, a radial guide channel, a moveable magnet, a first connecting channel, a sealing beam, a target chamber, a second connecting channel, and a first stationary magnet. In an exemplary embodiment, the inlet chamber may be configured to receive and store a fluid sample. In an exemplary embodiment, the inlet chamber may be placed between a center of the middle layer and the radial guide channel.

In an exemplary embodiment, the moveable magnet may be disposed slidably inside the radial guide channel between a proximal end of the radial guide channel and a distal end of the radial guide channel. In an exemplary embodiment, the first connecting channel may be interconnected between the inlet chamber and the radial guide channel. In an exemplary embodiment, a proximal end of the first connecting channel may be connected to the inlet channel. In an exemplary embodiment, a distal end of the first connecting channel may be connected to the radial guide channel. In an exemplary embodiment, the first connecting channel may be in fluid communication with the inlet chamber.

In an exemplary embodiment, the sealing beam may be disposed slidably inside the first connecting channel. In an exemplary embodiment, the sealing beam may be configured to move linearly inside the first connecting channel. In an exemplary embodiment, a distal end of the sealing beam may be attached to the moveable magnet. In an exemplary embodiment, the target chamber may be configured to receive and store the fluid sample.

In an exemplary embodiment, the second connecting channel may be interconnected between the first connecting channel and the target chamber. in an exemplary embodiment, a proximal end of the second connecting channel may be connected to an opening of the first connecting channel. In an exemplary embodiment, a distal end of the second connecting channel may be connected to the target chamber. In an exemplary embodiment, the second connecting channel may be in fluid communication with the first connecting channel and the target chamber.

In an exemplary embodiment, the first stationary magnet may be disposed adjacent the distal end of the radial guide channel. In an exemplary embodiment, the first stationary magnet may be configured to repel the moveable magnet due to magnetic repulsion force between the first stationary magnet and the moveable magnet. In an exemplary embodiment, the first stationary magnet may be configured to urge the moveable magnet to move toward the proximal end of the radial guide channel inside the radial guide channel due to magnetic repulsion force between the first stationary magnet and the moveable magnet.

In an exemplary embodiment, when the middle layer rotates around the center of the middle layer with a speed less than a threshold rotational speed, a centrifugal force applied to the moveable magnet may become less than a magnetic repulsion force between the first stationary magnet and the moveable magnet. Furthermore, the moveable magnet may be placed at the proximal end of the radial guide channel, the sealing beam may block the opening, and the fluid sample may be prevented from flowing to the target chamber from the inlet chamber.

In an exemplary embodiment, when the middle layer rotates around the center of the middle layer with a speed greater than the threshold rotational speed, the centrifugal force applied to the moveable magnet may become greater than the magnetic repulsion force between the first stationary magnet and the moveable magnet. Furthermore, the moveable magnet may be placed at the distal end of the radial guide channel, the sealing beam may unblock the opening, and the fluid sample may be allowed to flow to the target chamber from the inlet chamber through the first connecting channel and the second connecting channel.

In an exemplary embodiment, a lower end of the moveable magnet and an upper end of the first stationary magnet may have a same magnetic pole. In an exemplary embodiment, the centrifugal microfluidic system may further include a second stationary magnet disposed adjacent the distal end of the radial guide channel. In an exemplary embodiment, the first stationary magnet may be attached to a left side of the distal end of the radial guide channel. In an exemplary embodiment, the second stationary magnet may be attached to a right side of the distal end of the radial guide channel.

In an exemplary embodiment, the lower end of the moveable magnet and an upper end of the second stationary magnet may have a same magnetic pole. In an exemplary embodiment, the lower end of the moveable magnet, the upper end of the first stationary magnet, and the upper end of the second stationary magnet may have one of a south magnetic pole and a north magnetic pole. In an exemplary embodiment, an outer diameter of the sealing beam may correspond to an inner diameter of the first connecting channel. In an exemplary embodiment, the sealing beam may be configured to prevent fluid leakage between a gap between the sealing beam and the first connecting channel.

In an exemplary embodiment, the centrifugal microfluidic system may include a center hole at a center of the centrifugal microfluidic system. In an exemplary embodiment, the centrifugal microfluidic system may be configured to be mounted onto a rotator device at the center hole. In an exemplary embodiment, the rotator device may be configured to rotate the centrifugal microfluidic system around a rotation axis of the centrifugal microfluidic system.

In an exemplary embodiment, a main axis of the radial guide channel may coincide with a radius of the middle layer. In an exemplary embodiment, the main axis of the radial guide channel may coincide with a main axis of the first connecting channel.

In an exemplary embodiment, the first stationary magnet may be disposed adjacent the proximal end of the radial guide channel. In an exemplary embodiment, the first stationary magnet may be configured to attract the moveable magnet due to magnetic attraction force between the first stationary magnet and the moveable magnet. In an exemplary embodiment, the first stationary magnet may be configured to urge the moveable magnet to move toward the proximal end of the radial guide channel inside the radial guide channel due to magnetic attraction force between the first stationary magnet and the moveable magnet.

In an exemplary embodiment, when the middle layer rotates around the center of the middle layer with a speed less than a threshold rotational speed, a centrifugal force applied to the moveable magnet may become less than a magnetic attraction force between the first stationary magnet and the moveable magnet. Furthermore, the moveable magnet may be placed at the proximal end of the radial guide channel, the sealing beam may block the opening, and the fluid sample may be prevented from flowing to the target chamber from the inlet chamber.

In an exemplary embodiment, when the middle layer rotates around the center of the middle layer with a speed greater than the threshold rotational speed, the centrifugal force applied to the moveable magnet may become greater than the magnetic attraction force between the first stationary magnet and the moveable magnet. Furthermore, the moveable magnet may be placed at the distal end of the radial guide channel, the sealing beam may unblock the opening, and the fluid sample may be allowed to flow to the target chamber from the inlet chamber through the first connecting channel and the second connecting channel.

In an exemplary embodiment, an upper end of the moveable magnet and a lower end of the first stationary magnet may have a same magnetic pole. In an exemplary embodiment, the centrifugal microfluidic system may further include a second stationary magnet disposed adjacent the proximal end of the radial guide channel. In an exemplary embodiment, the first stationary magnet may be attached to a left side of the proximal end of the radial guide channel. In an exemplary embodiment, the second stationary magnet may be attached to a right side of the proximal end of the radial guide channel. In an exemplary embodiment, the upper end of the moveable magnet and a lower end of the second stationary magnet may have opposite magnetic poles.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an exploded view of a centrifugal microfluidic system, consistent with one or more exemplary embodiments of the present disclosure.

FIG. 2A illustrates a perspective view of an exemplary middle layer, consistent with one or more exemplary embodiments of the present disclosure.

FIG. 2B illustrates a top view of an exemplary middle layer, consistent with one or more exemplary embodiments of the present disclosure.

FIG. 2C illustrates another top view of an exemplary middle layer, consistent with one or more exemplary embodiments of the present disclosure.

FIG. 2D illustrates a radial guide channel and a first connecting channel, consistent with one or more exemplary embodiments of the present disclosure.

FIG. 2E illustrates a sealing beam, a first connecting channel, a radial guide channel, and a moveable magnet, consistent with one or more exemplary embodiments of the present disclosure.

FIG. 2F illustrates a first connecting channel, a second connecting channel, and a radial guide channel, consistent with one or more exemplary embodiments of the present disclosure.

FIG. 2G illustrates a system in a scenario in which a moveable magnet is placed at a proximal end of a radial guide channel, consistent with one or more exemplary embodiments of the present disclosure.

FIG. 2H illustrates a system in a scenario in which a moveable magnet is placed at a distal end of a radial guide channel, consistent with one or more exemplary embodiments of the present disclosure.

FIG. 3A illustrates a system in a scenario in which the system rotates with a speed less than the threshold speed, consistent with one or more exemplary embodiments of the present disclosure.

FIG. 3B illustrates a system in a scenario in which the system rotates with a speed greater than the threshold speed, consistent with one or more exemplary embodiments of the present disclosure.

FIG. 4A shows a perspective view of an exemplary middle layer, consistent with one or more exemplary embodiments of the present disclosure.

FIG. 4B shows a top view of an exemplary middle layer, consistent with one or more exemplary embodiments of the present disclosure.

FIG. 5A shows a system in a scenario in which the system rotates with a speed less than the threshold speed, consistent with one or more exemplary embodiments of the present disclosure.

FIG. 5B shows a system in a scenario in which the system rotates with a speed greater than the threshold speed, consistent with one or more exemplary embodiments of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

The present disclosure is directed to exemplary embodiments of a centrifugal microfluidic system. An exemplary system may include a middle layer which may be compacted between a top layer and a bottom layer. The system may be mounted on a rotator system which may cause the system to rotate around a rotational axis of the system. The middle layer may include an inlet chamber and a target chamber. a user may pour a fluid sample into the inlet chamber. A first connecting channel and a second connecting channel may be interconnected between the inlet chamber and the target chamber. A proximal end of the first connecting channel may be connected to a bottom side of the inlet chamber. A distal end of the first connecting channel may be connected to a radial guide channel in which a moveable magnet is disposed. The second connecting channel may be interconnected between the first connecting channel and the target chamber. A distal end of the second connecting channel may be connected to the target chamber. a proximal end of the second connecting channel may be connected to an opening of the first connecting channel.

A sealing beam may be disposed inside the first connecting channel. A distal end of the sealing beam may be attached to the moveable magnet. When the moveable magnet placed at the proximal end of the radial guide channel, the sealing beam may block the opening of the first connecting channel and, to thereby, prevent the fluid sample from going from the inlet chamber into the target chamber. when the moveable magnet is placed at the distal end of the radial guide chamber, the opening of the first connecting channel may be unblocked and, thereby, the fluid sample may be allowed to go from inlet chamber into the target chamber.

An exemplary system may include a pair of stationary magnets which may be attached to a distal end of the radial guide channel. A magnetic pole of the pair of stationary magnets may be the same as the pole of the moveable magnet. Therefore, the pair of stationary magnets may push the moveable magnet toward the proximal end of the radial guide channel. When the system rotates with a speed less than a threshold speed, a centrifugal force applied to the moveable magnet may be less than the magnetic repulsion force between the pair of stationary magnets and the moveable magnet and, thereby, the moveable magnet may be placed at the proximal end of the radial guide channel and, consequently, the opening may be blocked. When the system rotates with a speed greater than the threshold speed, the centrifugal force applied to the moveable magnet may be greater than the magnetic repulsion force between the pair of stationary magnets and the moveable magnet and, thereby, the moveable magnet may be placed at the distal end of the radial guide channel and, consequently, the opening may be unblocked.

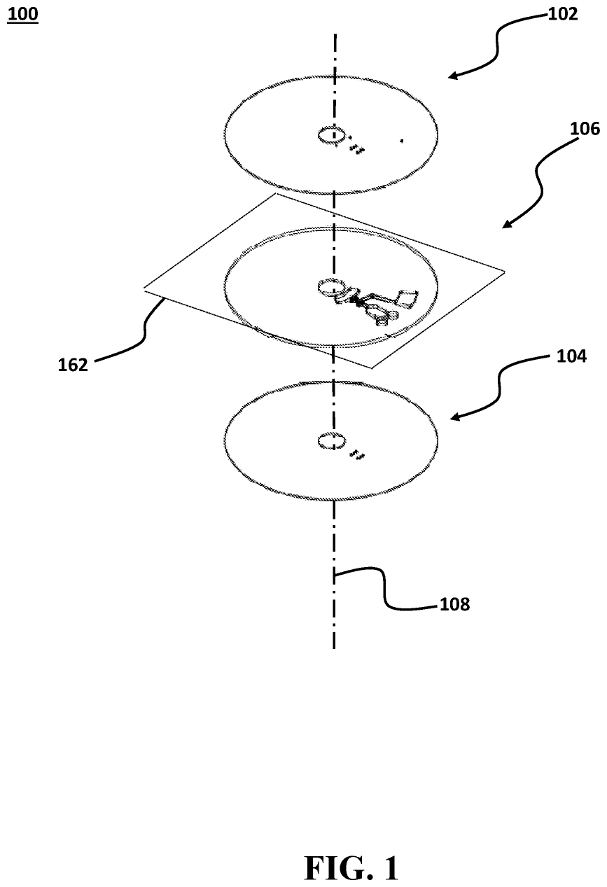

Herein is disclosed an exemplary centrifugal microfluidic system. FIG. 1 shows an exploded view of a centrifugal microfluidic system 100, consistent with one or more exemplary embodiments of the present disclosure. As shown in FIG. 1, in an exemplary embodiment, centrifugal microfluidic system 100 may include a top layer 102, a bottom layer 104, and a middle layer 106. In an exemplary embodiment, each of top layer 102, bottom layer 104, and middle layer 106 may have a disc shape. In an exemplary embodiment, middle layer 106 may be secured between top layer 102 and bottom layer 104. In an exemplary embodiment, middle layer 106 may be compacted between top layer 102 and bottom layer 104 to form a compact disc (CD)-shaped microfluidic system. In an exemplary embodiment, middle layer 106 may be compacted between top layer 102 and bottom layer 104 by pressing top layer 102 onto a top surface of middle layer 106 and pressing bottom layer 104 onto a bottom surface of middle layer 106. In an exemplary embodiment, middle layer 106 may be compacted between top layer 102 and bottom layer 104 in such a way that fluid does not leak from centrifugal microfluidic system 100. In an exemplary embodiment, an exemplary compact disc(CD)-shaped microfluidic system may be used to move a solution sample to an intended place using a centrifugal force due to rotation of an exemplary compact disc(CD)-shaped microfluidic system around a center of the compact disc(CD)-shaped microfluidic system.

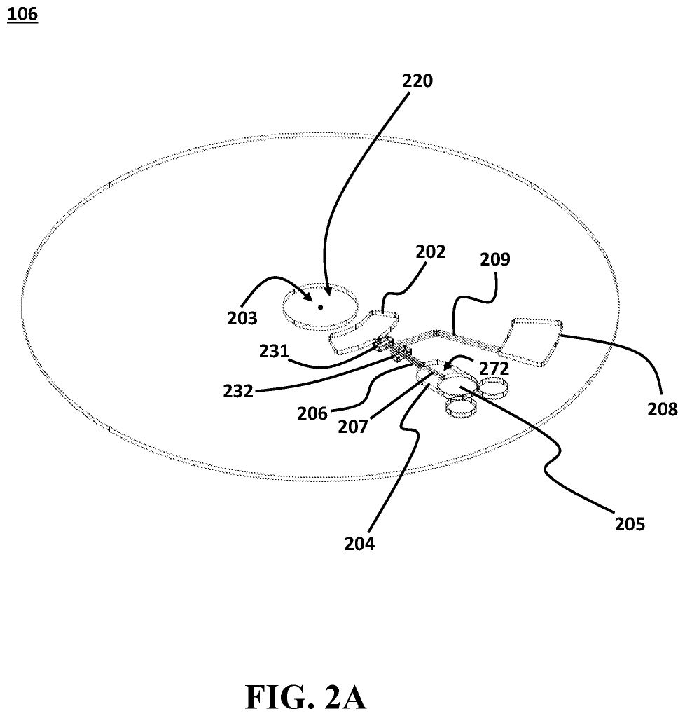

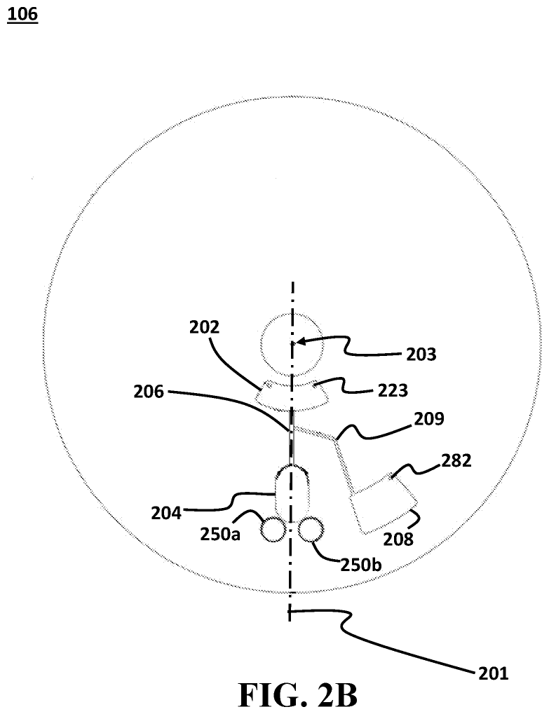

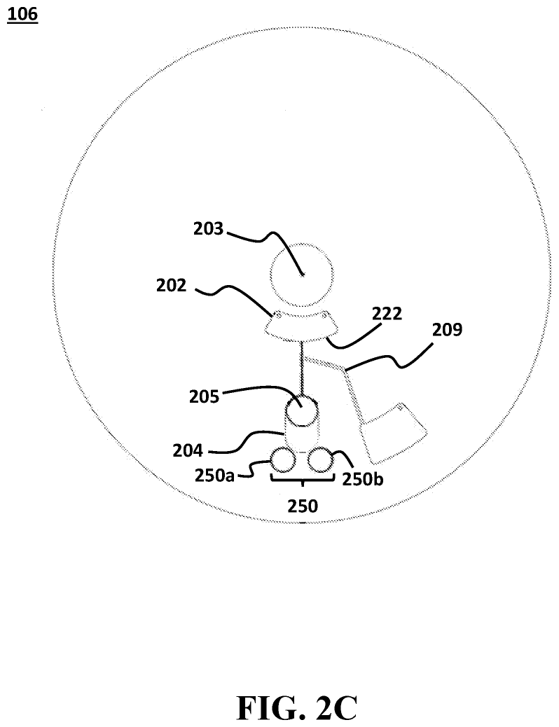

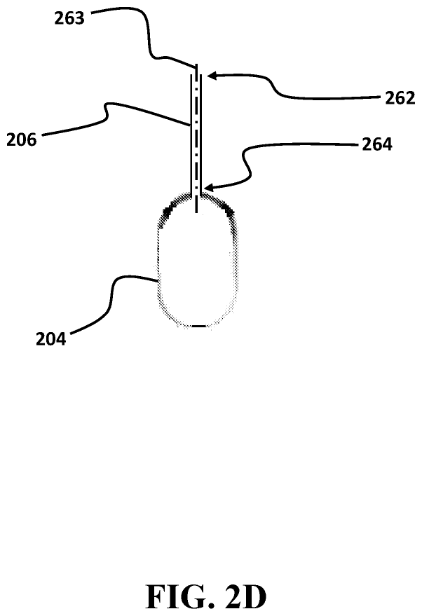

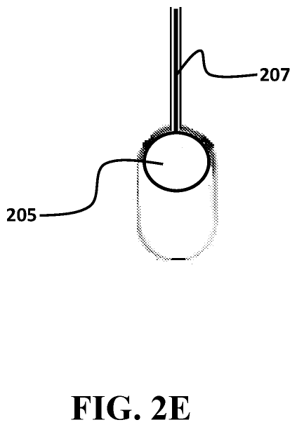

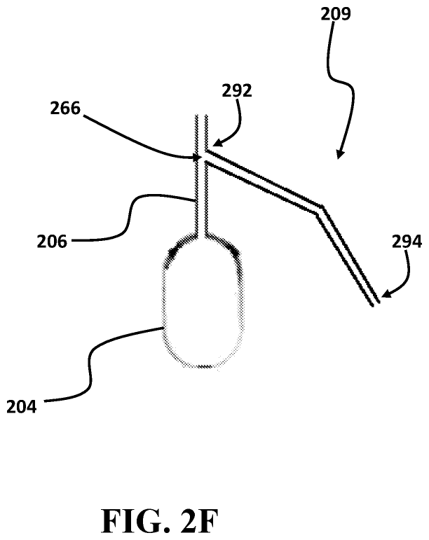

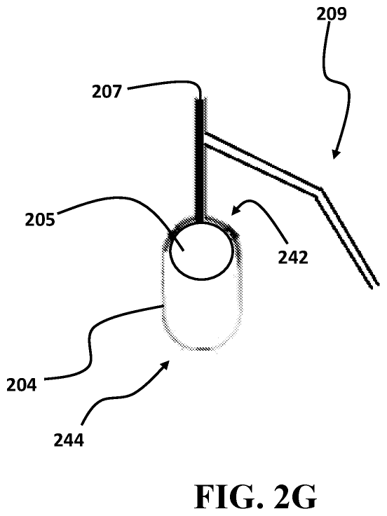

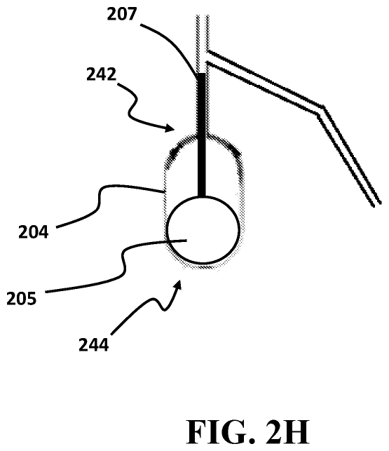

FIG. 2A shows a perspective view of an exemplary middle layer 106, consistent with one or more exemplary embodiments of the present disclosure. FIG. 2B shows a top view of an exemplary middle layer 106, consistent with one or more exemplary embodiments of the present disclosure. FIG. 2C shows another top view of an exemplary middle layer 106, consistent with one or more exemplary embodiments of the present disclosure. As shown in FIG. 2A, FIG. 2B, and FIG. 2C, in an exemplary embodiment, an exemplary middle layer 106 may include an inlet chamber 202. In an exemplary embodiment, middle layer 106 may be configured to receive and store fluid sample. In an exemplary embodiment, inlet chamber 202 may include a first air vent 223.

In an exemplary embodiment, middle layer 106 may further include a radial guide channel 204. In an exemplary embodiment, radial guide channel 204 may be extended along a radius of middle layer 106. As shown in FIG. 2B, in an exemplary embodiment, a main axis 201 of radial guide channel 204 may coincide a radius of middle layer 106. In other words, main axis 201 of radial guide channel may pass through a center 203 of middle layer 106. In an exemplary embodiment, main axis 201 of radial guide channel 204 may refer to a main longitudinal axis of radial guide channel 204. In an exemplary embodiment, the longitudinal axis of radial guide channel 204 may refer to a longitudinal axis of radial guide channel 204 which may be a symmetry axis of radial guide channel 204. As shown in FIG. 2A, FIG. 2B, and FIG. 2C, in an exemplary embodiment, inlet chamber 202 may be placed between center 203 of middle layer 106 and radial guide channel 204.

In an exemplary embodiment, middle layer 106 may further include a moveable magnet 205. In an exemplary embodiment, moveable magnet 205 may be disposed slidably inside radial guide channel 204. In an exemplary embodiment, when moveable magnet 205 is disposed slidably inside radial guide channel 204, moveable magnet 205 may be disposed inside radial guide channel 204 in such a way that moveable magnet 205 is limited to move linearly between a proximal end 242 of radial guide channel 204 and a distal end 244 of radial guide channel 204 and along main axis 201 of radial guide channel 204.

In an exemplary embodiment, middle layer 106 may further include a first connecting channel 206. FIG. 2D shows radial guide channel 204 and first connecting channel 206, consistent with one or more exemplary embodiments of the present disclosure. As shown in FIG. 2A, FIG. 2B, FIG. 2C, and FIG. 2D, in an exemplary embodiment, first connecting channel 206 may be interconnected between inlet chamber 202 and radial guide channel 204. In an exemplary embodiment, a proximal end 262 of first connecting channel 206 may be connected to inlet channel 202. In an exemplary embodiment, proximal end 262 of first connecting channel 206 may be connected to a bottom surface 222 of inlet chamber 202. In an exemplary embodiment, a distal end 264 of first connecting channel 206 may be connected to radial guide channel 204. In an exemplary embodiment, distal end 264 of first connecting channel 206 may be connected to proximal end 242 of radial guide channel 204. In an exemplary embodiment, a main axis 263 of first connecting channel 206 may coincide a main axis 201 of radial guide channel 204. In an exemplary embodiment, main axis 263 of first connecting channel 206 may refer to a main longitudinal axis of first connecting channel 206. In an exemplary embodiment, main longitudinal axis of first connecting channel 206 may refer to a longitudinal axis of first connecting channel 206 which may be a symmetry axis of first connecting channel 206. In an exemplary embodiment, first connecting channel 206 may be in fluid communication with inlet chamber 202 through proximal end 262 of first connecting channel 206. In other words, in an exemplary embodiment, fluid may flow from inlet chamber 202 into first connecting channel 206.

In an exemplary embodiment, middle layer 106 may further include a sealing beam 207. FIG. 2E shows sealing beam 207, first connecting channel 206, radial guide channel 204, and moveable magnet 205, consistent with one or more exemplary embodiments of the present disclosure. In an exemplary embodiment, sealing beam 207 may be disposed slidably inside first connecting channel 206. In an exemplary embodiment, when sealing beam 207 is disposed slidably inside first connecting channel 206, sealing beam 207 may move linearly inside first connecting channel 206 along main axis 201 of radial guide channel 204. In an exemplary embodiment, a distal end 272 of sealing beam 207 may be attached to moveable magnet 205. In an exemplary embodiment, the first layer may include a first sealing member 231 and a second sealing member 232. In an exemplary embodiment, first sealing member 231 and second sealing member 232 may be disposed inside first connecting channel 206. In an exemplary embodiment, first sealing member 231 and second sealing member 232 may be made up of a rubber material. In an exemplary embodiment, first sealing member 231 and second sealing member 232 may be configured to minimize fluid leakage in a gap between first connecting channel 206 and sealing beam 207.

In an exemplary embodiment, middle layer 106 may further include a target chamber 208. In an exemplary embodiment, target chamber 208 may be configured to receive and store fluid sample. In an exemplary embodiment, target chamber 208 may include a second air vent. In an exemplary embodiment, middle layer 106 may further include a second connecting channel 209. In an exemplary embodiment, second connecting channel 209 may be interconnected between first connecting channel 206 and target chamber 208. In an exemplary embodiment, a proximal end 292 of second connecting channel 209 may be connected to first connecting channel 206. In an exemplary embodiment, a distal end 294 of second connecting channel 209 may be connected to target chamber 208.

FIG. 2F shows first connecting channel 206, second connecting channel 209, and radial guide channel 204, consistent with one or more exemplary embodiments of the present disclosure. As shown in FIG. 2F, in an exemplary embodiment, first connecting channel 206 may include an opening 266 on a side surface of first connecting channel 206. In an exemplary embodiment, proximal end 292 of second connecting channel 209 may be connected to opening 266 of first connecting channel 206. In an exemplary embodiment, second connecting channel 209 may be in fluid communication with first connecting channel 206 and target chamber 208. In an exemplary embodiment, second connecting channel 209 may be in fluid communication with first connecting channel 206 through opening 266. In an exemplary embodiment, fluid may flow from first connecting channel 206 to second connecting channel 209 through opening 266.

FIG. 2G shows system 100 in a scenario in which moveable magnet 205 is placed at proximal end 242 of radial guide channel 204, consistent with one or more exemplary embodiments of the present disclosure. As shown in FIG. 2G, in an exemplary embodiment, when moveable magnet 205 is placed at proximal end 242 of radial guide channel 204, sealing beam 207 may block opening 266 of first connecting channel 206. In an exemplary embodiment, when opening 266 of first connecting channel 206 is blocked, fluid may be prevented from flowing from first connecting channel 206 to second connecting channel 209. In an exemplary embodiment, when opening 266 of first connecting channel 206 is blocked, as fluid is prevented from flowing from first connecting channel 206 to second connecting channel 209, fluid may be prevented from flowing from inlet chamber 202 to target chamber 208. In an exemplary embodiment, an outer diameter of sealing beam 207 may coincide with an inner diameter of first connecting channel 206. In an exemplary embodiment, when the outer diameter of sealing beam 207 coincides with the inner diameter of first connecting channel 206, it may mean that a difference between when the outer diameter of sealing beam 207 and the inner diameter of first connecting channel 206 is of such a size that while sealing beam 207 is allowed to move linearly inside first connecting channel 206 but liquid flow may not leak from the gap between sealing beam 207 and first connecting channel 206. In an exemplary embodiment, the inner diameter of first connecting channel 206 may be greater than the outer diameter of sealing beam 207 by an amount of 0.01 millimeters.

FIG. 2H shows system 100 in a scenario in which moveable magnet 205 is placed at distal end 244 of radial guide channel 204, consistent with one or more exemplary embodiments of the present disclosure. As shown in FIG. 2H, in an exemplary embodiment, when moveable magnet 205 is placed at distal end 244 of radial guide channel 204, opening 266 of first connecting channel 206 may be unblocked. In an exemplary embodiment, when opening 266 of first connecting channel 206 is unblocked, fluid may be allowed to flow from first connecting channel 206 into second connecting channel 209. In an exemplary embodiment, when opening 266 of first connecting channel 206 is unblocked, fluid may be allowed to flow from inlet chamber 202 to target chamber 208.

As further shown in FIG. 2A, FIG. 2B, and FIG. 2C, in an exemplary embodiment, middle layer 106 may further include a pair of stationary magnets 250. In an exemplary embodiment, pair of stationary magnets 250 may include a first stationary magnet 250a and a second stationary magnet 250b. In an exemplary embodiment, pair of stationary magnets 250 may be disposed adjacent distal end 244 of radial guide channel 204. In an exemplary embodiment, first stationary magnet 250a and second stationary magnet 250b may be attached to distal end 244 of radial guide channel 204.

In an exemplary embodiment, first stationary magnet 250a and second stationary magnet 250b may be configured to repel moveable magnet 205 due to magnetic repulsion force between pair of stationary magnets 250 and moveable magnet 205. In an exemplary embodiment, an upper end of first stationary magnet 250a and a lower end of moveable magnet 205 may have a same magnetic pole. In an exemplary embodiment, the upper end of first stationary magnet 250a may refer to an end of first stationary magnet 250a which is closer to center 203 of middle layer 106. In an exemplary embodiment, the lower end of moveable magnet 205 may refer to an end of moveable magnet 205 which may be further from center 203 of middle layer 106. In an exemplary embodiment, an upper end of second stationary magnet 250b and the lower end of moveable magnet 205 may have a same magnetic pole. In an exemplary embodiment, the upper end of second stationary magnet 250b may refer to an end of second stationary magnet 250b which may be closer to center 203 of middle layer 106. In an exemplary embodiment, the upper end of first stationary magnet 250a and the upper end of second stationary magnet 250b may have a same magnetic pole. In an exemplary embodiment, the upper end of first stationary magnet 250a and the upper end of second stationary magnet 250b may have a north magnetic pole and the lower end of moveable magnet 205 may also have a north magnetic pole. In another embodiment, the upper end of first stationary magnet 250a and the upper end of second stationary magnet 250b may have a south magnetic pole and the lower end of moveable magnet 205 may also have a south magnetic pole.

In an exemplary embodiment, first stationary magnet 250a and second stationary magnet 250b may be configured to urge moveable magnet 205 to move toward proximal end 242 of radial guide channel 204. In an exemplary embodiment, the magnetic repulsion force between pair of stationary magnets 250 and moveable magnet 205 may push moveable magnet 205 away from pair of stationary magnets 250. In an exemplary embodiment, as moveable magnet 205 may be limited to move linearly inside radial guide channel 204 along main axis 201 of radial guide channel 204, the magnetic repulsion force between pair of stationary magnets 250 and moveable magnet 205 may urge moveable magnet 205 to move toward proximal end 242 of radial guide channel 204.

In an exemplary embodiment, system 100 may include a central hole 220 at center 203 of middle layer 106. In an exemplary embodiment, central hole 220 may be configured to receive a rotator device. In an exemplary embodiment the rotator device may cause system 100 to rotate around a rotation axis 108. In an exemplary embodiment, rotation axis 108 may be perpendicular to a main plane 162 of middle layer 106. In an exemplary embodiment, rotation axis 108 may pass through center 203 of middle layer 106. In an exemplary embodiment, main plane 162 may refer to a plane coinciding the top surface of middle layer 106.

In an exemplary embodiment, when system 100 rotates around rotation axis 108, a centrifugal force due to rotation of system 100 around rotation axis 108 may urge moveable magnet 205 to move away from center 203 of middle layer 106. In an exemplary embodiment, as moveable magnet 205 may be limited to move linearly along main axis 201 of radial guide channel 204 and inside radial guide channel 204, the centrifugal force due to rotation of system 100 around rotation axis 108 may urge moveable magnet 205 to move toward distal end 244 of radial guide channel 204. In an exemplary embodiment, higher rotation speed of system 100 around rotation axis 108 may bring greater centrifugal force.

In an exemplary embodiment, when system 100 rotates around rotation axis 108 with a speed less than a threshold rotational speed, the centrifugal force applied to moveable magnet 205 may be less than the magnetic repulsion force between pair of stationary magnets 250 and moveable magnet 205. In an exemplary embodiment, it may be understood that the magnitude of the centrifugal force applied to moveable magnet 205 may be a function of the rotational speed of system 100 around axis 108. In an exemplary embodiment, the threshold rotational speed may refer to a rotational speed of system 100 around axis 108 at which the centrifugal force applied to moveable magnet 205 is equal to the magnetic repulsion force between pair of stationary magnets 250 and moveable magnet 205. In an exemplary embodiment, the threshold rotational speed may be in a range between 3500 rpm and 4500 rpm. In an exemplary embodiment, when the centrifugal force applied to moveable magnet 205 is less than the magnetic repulsion force between pair of stationary magnets 250 and moveable magnet 205, moveable magnet 205 may be placed at proximal end 242 of radial guide channel 204 and, thereby, sealing beam 207 may block opening 266. Therefore, in an exemplary embodiment, when system 100 rotates around rotation axis 108 with a speed less than a threshold rotational speed, fluid sample inside inlet chamber 202 may be prevented from going into target chamber 208.

In an exemplary embodiment, when system 100 rotates around rotation axis 108 with a speed greater than the threshold rotational speed, the centrifugal force applied to moveable magnet 205 may be greater than the magnetic repulsion force between pair of stationary magnets 250 and moveable magnet 205. In an exemplary embodiment, when the centrifugal force applied to moveable magnet 205 is greater than the magnetic repulsion force between pair of stationary magnets 250 and moveable magnet 205, moveable magnet 205 may be placed at distal end 244 of radial guide channel 204 and, thereby, opening 266 may be unblocked. Therefore, in an exemplary embodiment, when system 100 rotates around rotation axis 108 with a speed greater than a threshold rotational speed, fluid sample inside inlet chamber 202 may be allowed to go into target chamber 208. In an exemplary embodiment, by decreasing the rotational frequency, opening 266 may be blocked again and this feature may make it possible to just pump a certain amount of liquid into target chamber 208. In an exemplary embodiment, this feature may be used as a pump in a way that after decelerating system 100, moveable magnet 205 may move radially inward and may push the fluid sample in an inward direction.

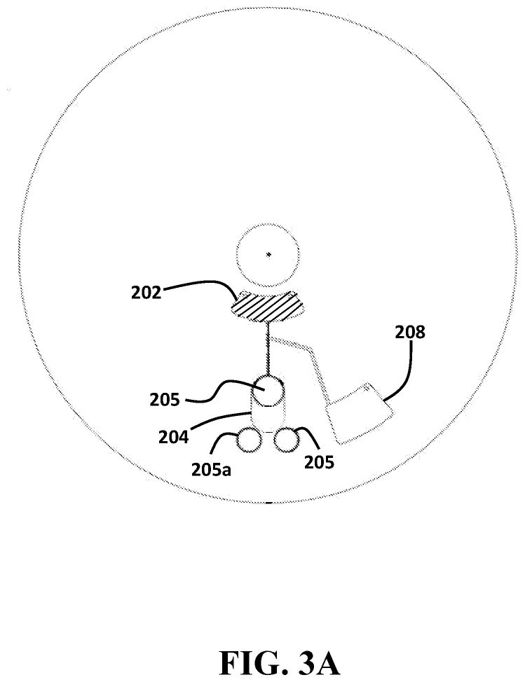

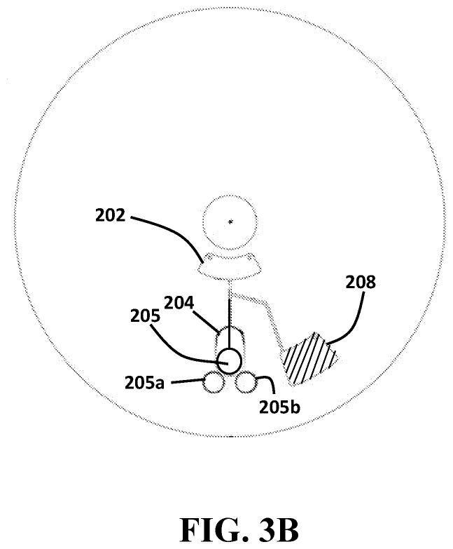

FIG. 3A shows system 100 in a scenario in which system 100 rotates with a speed less than the threshold speed, consistent with one or more exemplary embodiments of the present disclosure. As shown in FIG. 3A, when system 100 rotates around rotation axis 108 with a speed less than the threshold rotational speed, the fluid sample may be prevented to go from inlet chamber 202 to target chamber 208 and, consequently, the fluid sample may be stored in inlet chamber 202.

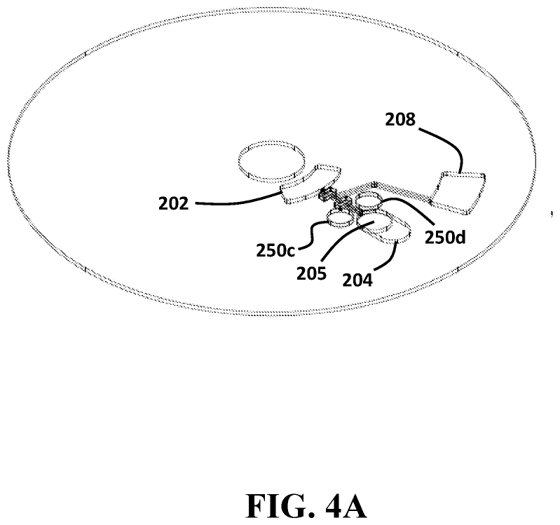

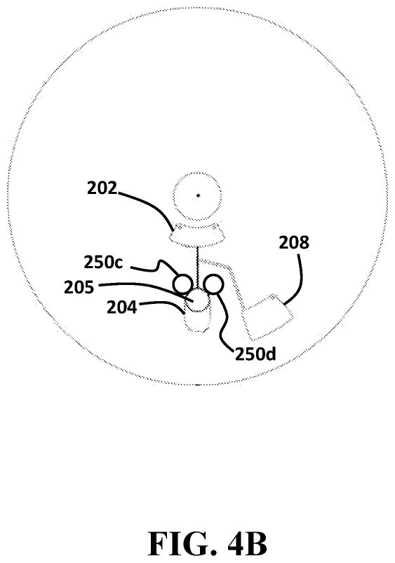

FIG. 3B shows system 100 in a scenario in which system 100 rotates with a speed greater than the threshold speed, consistent with one or more exemplary embodiments of the present disclosure. As shown in FIG. 3B, when system 100 rotates around rotation axis 108 with a speed greater than the threshold rotational speed, the fluid sample may flow from inlet chamber 202 to target chamber 208 and, consequently, the fluid sample may be stored in target chamber 208.
FIG. 4A shows a perspective view of an exemplary middle layer 106, consistent with one or more exemplary embodiments of the present disclosure. FIG. 4B shows a top view of an exemplary middle layer 106, consistent with one or more exemplary embodiments of the present disclosure. As shown in FIG. 4A and FIG. 4B, in an exemplary embodiment, middle layer 106 may include a second pair of stationary magnets including a third stationary magnet 250c and a fourth stationary magnet 250d. In an exemplary embodiment, third stationary magnet 250c and fourth stationary magnet 250d may be disposed adjacent proximal end 242 of radial guide channel 204. In an exemplary embodiment, third stationary magnet 250c and fourth stationary magnet 250d may be attached to proximal end 244 of radial guide channel 204.

In an exemplary embodiment, third stationary magnet 250c and fourth stationary magnet 250d may be configured to attract moveable magnet 205 due to magnetic attraction force between the second pair of stationary magnets and moveable magnet 205. In an exemplary embodiment, a lower end of third stationary magnet 250c and an upper end of moveable magnet 205 may have opposite magnetic poles. In an exemplary embodiment, the lower end of third stationary magnet 250c may refer to an end of third stationary magnet 250c which is further from center 203 of middle layer 106. In an exemplary embodiment, the upper end of moveable magnet 205 may refer to an end of moveable magnet 205 which may be closer to center 203 of middle layer 106. In an exemplary embodiment, a lower end of fourth stationary magnet 250d and the upper end of moveable magnet 205 may have opposite magnetic poles. In an exemplary embodiment, the lower end of fourth stationary magnet 250d may refer to an end of fourth stationary magnet 250d which may be further from center 203 of middle layer 106. In an exemplary embodiment, the lower end of third stationary magnet 250c and the lower end of fourth stationary magnet 250d may have a same magnetic pole. In an exemplary embodiment, the lower end of third stationary magnet 250c and the lower end of fourth stationary magnet 250d may have a north magnetic pole and the upper end of moveable magnet 205 may have a south magnetic pole. In another embodiment, the lower end of third stationary magnet 250c and the lower end of fourth stationary magnet 250d may have a south magnetic pole and moveable magnet 205 may have a north magnetic pole.

In an exemplary embodiment, third stationary magnet 250c and fourth stationary magnet 250d may be configured to urge moveable magnet 205 to move toward proximal end 242 of radial guide channel 204. In an exemplary embodiment, the magnetic attraction force between the second pair of stationary magnets and moveable magnet 205 may pull moveable magnet 205 toward the second pair of stationary magnets. In an exemplary embodiment, as moveable magnet 205 may be limited to move linearly inside radial guide channel 204 along main axis 201 of radial guide channel 204, the magnetic attraction force between the second pair of stationary magnets and moveable magnet 205 may urge moveable magnet 205 to move toward proximal end 242 of radial guide channel 204.

In an exemplary embodiment, when system 100 rotates around rotation axis 108, a centrifugal force due to rotation of system 100 around rotation axis 108 may urge moveable magnet 205 to move away from center 203 of middle layer 106. In an exemplary embodiment, as moveable magnet 205 may be limited to move linearly along main axis 201 of radial guide channel 204 and inside radial guide channel 204, the centrifugal force due to rotation of system 100 around rotation axis 108 may urge moveable magnet 205 to move toward distal end 244 of radial guide channel 204. In an exemplary embodiment, higher rotation speed of system 100 around rotation axis 108 may bring greater centrifugal force.

In an exemplary embodiment, when system 100 rotates around rotation axis 108 with a speed less than a threshold rotational speed, the centrifugal force applied to moveable magnet 205 may be less than the magnetic attraction force between the second pair of stationary magnets and moveable magnet 205. In an exemplary embodiment, it may be understood that the magnitude of the centrifugal force applied to moveable magnet 205 may be a function of the rotational speed of system 100 around axis 108. In an exemplary embodiment, the threshold rotational speed may refer to a rotational speed of system 100 around axis 108 at which the centrifugal force applied to moveable magnet 205 is equal to the magnetic repulsion force between pair of stationary magnets 250 and moveable magnet 205. In an exemplary embodiment, the threshold rotational speed may be in a range between 3500 rpm and 4500 rpm. In an exemplary embodiment, when the centrifugal force applied to moveable magnet 205 is less than the magnetic attraction force between the second pair of stationary magnets and moveable magnet 205, moveable magnet 205 may be placed at proximal end 242 of radial guide channel 204 and, thereby, sealing beam 207 may block opening 266. Therefore, in an exemplary embodiment, when system 100 rotates around rotation axis 108 with a speed less than a threshold rotational speed, fluid sample inside inlet chamber 202 may be prevented from going into target chamber 208.

In an exemplary embodiment, when system 100 rotates around rotation axis 108 with a speed greater than the threshold rotational speed, the centrifugal force applied to moveable magnet 205 may be greater than the magnetic attraction force between the second pair of stationary magnets and moveable magnet 205. In an exemplary embodiment, when the centrifugal force applied to moveable magnet 205 is greater than the magnetic attraction force between the second pair of stationary magnets and moveable magnet 205, moveable magnet 205 may be placed at distal end 244 of radial guide channel 204 and, thereby, opening 266 may be unblocked. Therefore, in an exemplary embodiment, when system 100 rotates around rotation axis 108 with a speed greater than a threshold rotational speed, fluid sample inside inlet chamber 202 may be allowed to go into target chamber 208. In an exemplary embodiment, when system 100 rotates around rotation axis 108 with an increasing speed, suddenly after reaching the threshold rotational speed, moveable magnet 205 moves from proximal end 242 of radial guide channel 204 to distal end 244 of radial guide channel 204.

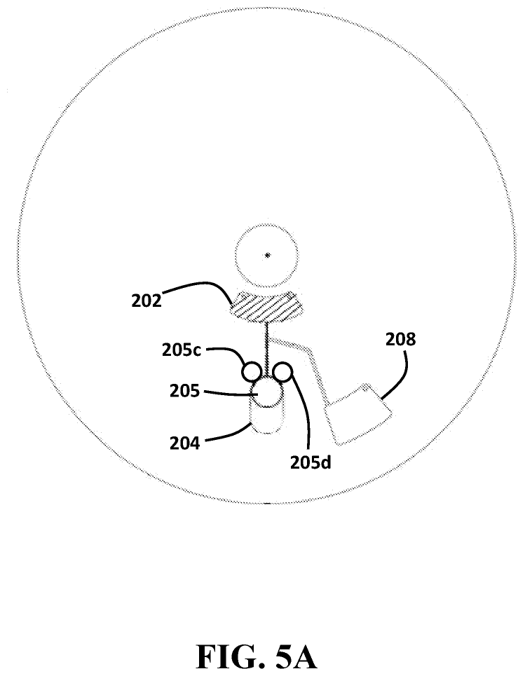

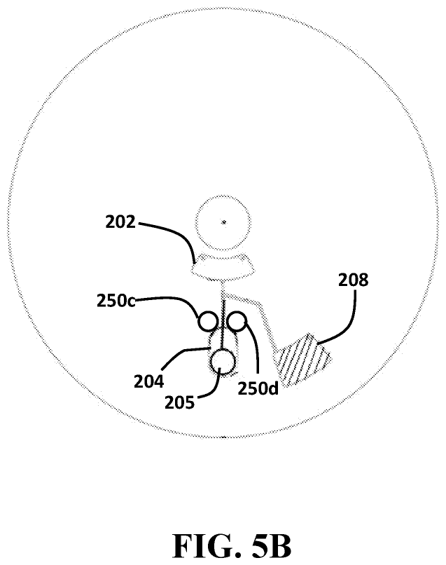

FIG. 5A shows system 100 in a scenario in which system 100 rotates with a speed less than the threshold speed, consistent with one or more exemplary embodiments of the present disclosure. As shown in FIG. 5A, when system 100 rotates around rotation axis 108 with a speed less than the threshold rotational speed, the fluid sample may be prevented to go from inlet chamber 202 to target chamber 208 and, consequently, the fluid sample may be stored in inlet chamber 202.

FIG. 5B shows system 100 in a scenario in which system 100 rotates with a speed greater than the threshold speed, consistent with one or more exemplary embodiments of the present disclosure. As shown in FIG. 5B, when system 100 rotates around rotation axis 108 with a speed greater than the threshold rotational speed, the fluid sample may flow from inlet chamber 202 to target chamber 208 and, consequently, the fluid sample may be stored in target chamber 208.

In an exemplary embodiment, system 100 disclosed above may be used as a centrifugal microfluidic platform which is also known as lab-on-a-disc system. In an exemplary embodiment, system 100 may be used as a semi-active micro-valve and/or micro-pump.

While the foregoing has described what may be considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Ends 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective spaces of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A centrifugal microfluidic system, comprising:
a top layer;
a bottom layer;
a middle layer secured between the top layer and the bottom layer, the middle layer comprising:
an inlet chamber configured to receive and store a fluid sample;
a radial guide channel, the inlet chamber placed between a center of the middle layer and the radial guide channel;
a moveable magnet disposed slidably inside the radial guide channel, the moveable magnet configured to move linearly inside the radial guide channel between a proximal end of the radial guide channel and a distal end of the radial guide channel;
a first connecting channel interconnected between the inlet chamber and the radial guide channel, a proximal end of the first connecting channel connected to the inlet channel, a distal end of the first connecting channel connected to the radial guide channel, the first connecting channel in fluid communication with the inlet chamber;
a sealing beam disposed slidably inside the first connecting channel, the sealing beam configured to move linearly inside the first connecting channel, a distal end of the sealing beam attached to the moveable magnet;
a target chamber configured to receive and store the fluid sample;
a second connecting channel interconnected between the first connecting channel and the target chamber, a proximal end of the second connecting channel connected to an opening of the first connecting channel, a distal end of the second connecting channel connected to the target chamber, the second connecting channel in fluid communication with the first connecting channel and the target chamber; and
a first stationary magnet disposed adjacent the distal end of the radial guide channel, the first stationary magnet configured to repel the moveable magnet due to magnetic repulsion force between the first stationary magnet and the moveable magnet, the first stationary magnet configured to urge the moveable magnet to move toward the proximal end of the radial guide channel inside the radial guide channel due to magnetic repulsion force between the first stationary magnet and the moveable magnet,
wherein:
responsive to rotating the middle layer around the center of the middle layer with a speed less than a threshold rotational speed,
a centrifugal force applied to the moveable magnet becomes less than a magnetic repulsion force between the first stationary magnet and the moveable magnet,
the moveable magnet is placed at the proximal end of the radial guide channel,
the sealing beam blocks the opening, and
the fluid sample is prevented from flowing to the target chamber from the inlet chamber, and
responsive to rotating the middle layer around the center of the middle layer with a speed greater than the threshold rotational speed,
the centrifugal force applied to the moveable magnet becomes greater than the magnetic repulsion force between the first stationary magnet and the moveable magnet,
the moveable magnet is placed at the distal end of the radial guide channel,
the sealing beam unblocks the opening, and
the fluid sample is allowed to flow to the target chamber from the inlet chamber through the first connecting channel and the second connecting channel.

2. The centrifugal microfluidic system of claim 1, wherein a lower end of the moveable magnet and an upper end of the first stationary magnet have a same magnetic pole.

3. The centrifugal microfluidic system of claim 2, further comprising a second stationary magnet disposed adjacent the distal end of the radial guide channel, wherein:
the first stationary magnet is attached to a left side of the distal end of the radial guide channel, and
the second stationary magnet is attached to a right side of the distal end of the radial guide channel.

4. The centrifugal microfluidic system of claim 3, wherein the lower end of the moveable magnet and an upper end of the second stationary magnet have a same magnetic pole.

5. The centrifugal microfluidic system of claim 4, wherein the lower end of the moveable magnet, the upper end of the first stationary magnet, and the upper end of the second stationary magnet have one of a south magnetic pole and a north magnetic pole.

6. The centrifugal microfluidic system of claim 5, wherein an outer diameter of the sealing beam corresponds to an inner diameter of the first connecting channel, the sealing beam configured to prevent fluid leakage between a gap between the sealing beam and the first connecting channel.

7. The centrifugal microfluidic system of claim 6, further comprising a center hole at a center of the centrifugal microfluidic system, the centrifugal microfluidic system configured to be mounted onto a rotator device at the center hole, the rotator device configured to rotate the centrifugal microfluidic system around a rotation axis of the centrifugal microfluidic system.

8. The centrifugal microfluidic system of claim 7, wherein a main axis of the radial guide channel coincides with a radius of the middle layer.

9. The centrifugal microfluidic system of claim 8, wherein the main axis of the radial guide channel coincides with a main axis of the first connecting channel.

10. The centrifugal microfluidic system of claim 9, wherein the middle layer further comprises a sealing member disposed inside the first connecting channel, the sealing member configured to prevent fluid leakage from the inlet chamber into the second connecting channel through the first connecting channel, the sealing member made up of a rubber material.

11. A centrifugal microfluidic system, comprising:
a top layer;
a bottom layer;
a middle layer secured between the top layer and the bottom layer, the middle layer comprising:
an inlet chamber configured to receive and store a fluid sample;
a radial guide channel, the inlet chamber placed between a center of the middle layer and the radial guide channel;
a moveable magnet disposed slidably inside the radial guide channel, the moveable magnet configured to move linearly inside the radial guide channel between a proximal end of the radial guide channel and a distal end of the radial guide channel;
a first connecting channel interconnected between the inlet chamber and the radial guide channel, a proximal end of the first connecting channel connected to the inlet channel, a distal end of the first connecting channel connected to the radial guide channel, the first connecting channel in fluid communication with the inlet chamber;
a sealing beam disposed slidably inside the first connecting channel, the sealing beam configured to move linearly inside the first connecting channel, a distal end of the sealing beam attached to the moveable magnet;
a target chamber configured to receive and store the fluid sample;
a second connecting channel interconnected between the first connecting channel and the target chamber, a proximal end of the second connecting channel connected to an opening of the first connecting channel, a distal end of the second connecting channel connected to the target chamber, the second connecting channel in fluid communication with the first connecting channel and the target chamber;
a first stationary magnet disposed adjacent the proximal end of the radial guide channel, the first stationary magnet configured to attract the moveable magnet due to magnetic attraction force between the first stationary magnet and the moveable magnet, the first stationary magnet configured to urge the moveable magnet to move toward the proximal end of the radial guide channel inside the radial guide channel due to magnetic attraction force between the first stationary magnet and the moveable magnet,
wherein:
responsive to rotating the middle layer around the center of the middle layer with a speed less than a threshold rotational speed,
a centrifugal force applied to the moveable magnet becomes less than a magnetic attraction force between the first stationary magnet and the moveable magnet,
the moveable magnet is placed at the proximal end of the radial guide channel,
the sealing beam blocks the opening, and
fluid sample is prevented from flowing to the target chamber from the inlet chamber, and
responsive to rotating the middle layer around the center of the middle layer with a speed greater than the threshold rotational speed,
the centrifugal force applied to the moveable magnet becomes greater than the magnetic attraction force between the first stationary magnet and the moveable magnet,
the moveable magnet is placed at the distal end of the radial guide channel,
the sealing beam unblocks the opening, and
fluid sample is allowed to flow to the target chamber from the inlet chamber through the first connecting channel and the second connecting channel.

12. The centrifugal microfluidic system of claim 11, wherein an upper end of the moveable magnet and a lower end of the first stationary magnet have opposite magnetic poles.

13. The centrifugal microfluidic system of claim 12, further comprising a second stationary magnet disposed adjacent the proximal end of the radial guide channel, wherein:
the first stationary magnet is attached to a left side of the proximal end of the radial guide channel, and
the second stationary magnet is attached to a right side of the proximal end of the radial guide channel.

14. The centrifugal microfluidic system of claim 13, wherein the upper end of the moveable magnet and a lower end of the second stationary magnet have opposite magnetic poles.

15. The centrifugal microfluidic system of claim 14, wherein an outer diameter of the sealing beam corresponds to an inner diameter of the first connecting channel, the sealing beam configured to prevent fluid leakage between a gap between the sealing beam and the first connecting channel.

16. The centrifugal microfluidic system of claim 15, further comprising a center hole at a center of the centrifugal microfluidic system, the centrifugal microfluidic system configured to be mounted onto a rotator device at the center hole, the rotator device configured to rotate the centrifugal microfluidic system around a rotation axis of the centrifugal microfluidic system.

17. The centrifugal microfluidic system of claim 16, wherein a main axis of the radial guide channel coincides with a radius of the middle layer.

18. The centrifugal microfluidic system of claim 17, wherein the main axis of the radial guide channel coincides with a main axis of the first connecting channel.

19. The centrifugal microfluidic system of claim 18, wherein the middle layer further comprises a sealing member disposed inside the first connecting channel, the sealing member configured to prevent fluid leakage from the inlet chamber into the second connecting channel through the first connecting channel, the sealing member made up of a rubber material.
